(19) United States
(12) Patent Application Publication
(10) Pub. No.: US 2021/0371100 A1
(43) Pub. Date: Dec. 2, 2021

(54) LIFT AND DRIVE UNIT, AIRCRAFT, AND SUBMARINE VEHICLE

(71) Applicant: 2706649 Ontario Ltd, Aurora (CA)

(72) Inventors: Mark FERTMAN, Toronto (CA); Gerard CAMPEAU, Newmarket (CA)

(21) Appl. No.: 17/116,652

(22) Filed: Dec. 9, 2020

(30) Foreign Application Priority Data
Dec. 9, 2019 (EP) 19214329.5

(51) Int. Cl. B64C 39/02; B63G 8/12; B63H 21/17; B60L 50/70; B63G 8/00; B63H 21/14; B63G 8/14

(52) U.S. Cl. CPC B64C 39/024; B63G 8/12; B63H 21/17; B60L 50/70; B63G 8/001; B64C 2201/027; B63G 8/14; B60L 2200/10; B60L 2200/32; B63G 2008/002; B64C 2201/022; B63H 21/14

(57) ABSTRACT

A lift and drive unit for an aircraft or submarine vehicle may include a hydrogen based drive component for providing a forward drive force to move the aircraft or vehicle over ground, and a hydrogen-based lift component for providing an upward drive force to move the aircraft or vehicle upward. An onboard hydrogen generating apparatus is connectable to both the drive component and the lift component, for providing the drive and lift components with hydrogen.

### CROSS REFERENCES

The following applications and materials are incorporated herein, in their entireties, for all purposes: U.S. patent application Ser. No. 17/107,412, filed Nov. 30, 2020.

### FIELD

This disclosure relates to systems and methods for propelling flying and submersible vehicles. More specifically, the disclosed embodiments relate to lift and drive mechanisms for aircraft and submarines.

### SUMMARY

The present disclosure provides systems, apparatuses, and methods relating to lift and drive mechanisms for aircraft and submersible vehicles.

In some embodiments, a lift and drive unit for an aircraft or submarine vehicle may include: a hydrogen-based drive component configured to provide a forward drive force to propel the aircraft or submarine vehicle over ground; a hydrogen-based lift component configured to provide an upward drive force to move the aircraft or submarine vehicle upward; and a hydrogen generating apparatus, connectable to both the drive component and the lift component, configured to supply the drive and lift components with a hydrogen supply which is produced within the lift and drive unit.

In some embodiments, the lift and drive unit may be included in a drone aircraft.

In some embodiments, the lift and drive unit may be included in a submarine vehicle.

Features, functions, and advantages may be achieved independently in various embodiments of the present disclosure, or may be combined in yet other embodiments, further details of which can be seen with reference to the following description and drawings.

### BRIEF DESCRIPTION OF THE DRAWINGS

FIG. 1 is a schematic block diagram depicting a simple lift and drive unit according aspects of the present disclosure.

FIG. 2 is another illustrative embodiment of a lift and drive unit according to aspects of the present disclosure.

FIG. 3 is a more sophisticated illustrative embodiment of a simple lift and drive unit according to aspects of the present disclosure.

FIG. 4A depicts an illustrative drone of the present disclosure, in a perspective view, in a first mode of operation.

FIG. 4B depicts the drone of FIG. 4A in a side view, in a second mode of operation.

FIG. 5A depicts a diver assistance vehicle of the present disclosure, in a first state of an exemplary use.

FIG. 5B depicts the diver assistance vehicle of FIG. 5A, in a second state of an exemplary use.

### DETAILED DESCRIPTION

Various aspects and examples of lift and drive mechanisms for aircraft and submersible vehicles, as well as related methods, are described below and illustrated in the associated drawings. Unless otherwise specified, a lift and drive mechanism in accordance with the present teachings, and/or its various components, may contain at least one of the structures, components, functionalities, and/or variations described, illustrated, and/or incorporated herein. Furthermore, unless specifically excluded, the process steps, structures, components, functionalities, and/or variations described, illustrated, and/or incorporated herein in connection with the present teachings may be included in other similar devices and methods, including being interchangeable between disclosed embodiments. The following description of various examples is merely illustrative in nature and is in no way intended to limit the disclosure, its application, or uses. Additionally, the advantages provided by the examples and embodiments described below are illustrative in nature and not all examples and embodiments provide the same advantages or the same degree of advantages.

### Definitions

The following definitions apply herein, unless otherwise indicated.

“Comprising,” “including,” and “having” (and conjugations thereof) are used interchangeably to mean including but not necessarily limited to, and are open-ended terms not intended to exclude additional, unrecited elements or method steps.

Terms such as “first”, “second”, and “third” are used to distinguish or identify various members of a group, or the like, and are not intended to show serial or numerical limitation.

“AKA” means “also known as,” and may be used to indicate an alternative or corresponding term for a given element or elements.

“Coupled” means connected, either permanently or releasably, whether directly or indirectly through intervening components.

“Processing logic” describes any suitable device(s) or hardware configured to process data by performing one or more logical and/or arithmetic operations (e.g., executing coded instructions). For example, processing logic may include one or more processors (e.g., central processing units (CPUs) and/or graphics processing units (GPUs)), microprocessors, clusters of processing cores, FPGAs (field-programmable gate arrays), artificial intelligence (AI) accelerators, digital signal processors (DSPs), and/or any other suitable combination of logic hardware.

A “controller” or “electronic controller” includes processing logic programmed with instructions to carry out a controlling function with respect to a control element. For example, an electronic controller may be configured to receive an input signal, compare the input signal to a selected control value or setpoint value, and determine an output signal to a control element (e.g., a motor or actuator) to provide corrective action based on the comparison. In another example, an electronic controller may be configured to interface between a host device (e.g., a desktop computer, a mainframe, etc.) and a peripheral device (e.g., a memory device, an input/output device, etc.) to control and/or monitor input and output signals to and from the peripheral device.

“Providing,” in the context of a method, may include receiving, obtaining, purchasing, manufacturing, generating, processing, preprocessing, and/or the like, such that the object or material provided is in a state and configuration for other steps to be carried out.

In this disclosure, one or more publications, patents, and/or patent applications may be incorporated by reference. However, such material is only incorporated to the extent that no conflict exists between the incorporated material and the statements and drawings set forth herein. In the event of any such conflict, including any conflict in terminology, the present disclosure is controlling.

### Overview

The present disclosure relates to a lift and drive unit of an aircraft or submarine vehicle which is fueled with hydrogen. It is further related to an aircraft and to a submarine vehicle which are provided with such lift and drive unit.

Hydrogen is supposed to be an important fuel for future land, water, and air vehicles having a fuel cell or a combustion engine adapted to be fueled by hydrogen. Its major advantage is the lack of any harmful emissions, and hydrogen is an inexhaustible fuel.

Whereas most of the efforts for developing hydrogen-driven vehicles are in the fields of automotive and cargo and cruise ships, recently hydrogen-based drive systems have been proposed even for drones and for submarine vehicles.

See, e.g.:
“FCair—The Complete Hydrogen Solution for Commercial UAVs”, currently available at https://info.ballard.com/informational-complete-hydrogen-uav-solution or
“Submarines—ThyssenKrupp Marine Systems”, currently available at https://www.thyssenkrupp-marinesystems.com/en/products-services/submarines or
“Pioneers in the submarine market”, currently available at https://www.siemens-energy.com/global/en/offerings/industrial-applications/marine/submarines.html.

All well-known approaches in this regard rely on hydrogen which is produced in advance and stored in a tank of the vehicle under very high pressure. The respective distribution and storage systems have to fulfill very high safety requirements. and are thus costly and difficult to handle and maintain.

The present disclosure provides a lift and drive unit for aircraft or submarine vehicles, which is advantageous over prior drive systems with regard to safety requirements and costs and which can, in particular, be used in small and light-weight aircraft and submarine vehicles with high efficiency.

In some examples, the lift and drive unit comprises a drive component for providing a forward drive force to move the aircraft or vehicle over ground and a lift component for providing an upward drive force to move the aircraft or vehicle upward, both of which are fueled by hydrogen.

Herein, the terms “fuel” or “fueled” are not restricted to a fuel for a combustion engine, but should be understood in a broad meaning, as the substance utilized to operate the lift and drive unit, be it in a fuel cell or combustion engine or simply filled into a balloon to raise a respective vehicle from ground. The terms “forward drive force” or “upward drive force” are likewise to be understood in a broad meaning, as forces which have at least a forward or upward vector component, respectively.

In some examples, the lift and drive unit comprises a hydrogen-generating apparatus, connectable to both the drive component and the lift component, for fueling the drive and lift components with hydrogen which is produced within the unit. The hydrogen-generating apparatus may be of a type which contains at least a cathode and a hydrogen-generating anode, emerged into an aqueous electrolyte contained in a vessel, and/or (additional) hydrogen-generating elements between the cathode and a simple anode. A new, highly efficient apparatus of such type is subject of the European Patent Application File No. EP 19212000 of the present Applicant, filed in the U.S. as U.S. patent application Ser. No. 17/107,412.

The onboard generation of hydrogen makes it possible to operate the lift and drive unit without previously stored hydrogen, i.e., in an aircraft or submarine vehicle which does not necessarily contain a high-pressure hydrogen tank and which, therefore, does not suffer from the drawbacks of such a tank and its associated high-pressure equipment. Even if, in some embodiments, in addition to the hydrogen-generating apparatus a hydrogen tank is provided in the aircraft or submarine vehicle, such tank and the corresponding equipment can be adapted to much lower pressures and, thus, have a simpler construction and less safety features, for the sake of lower costs and easier handling and maintenance.

In some examples, the drive component comprises a fuel cell coupled to at least one electric motor. The fuel cell, as well as the electric motor, can be of a conventional type which has proven to be applicable in an aircraft or a submarine vehicle, respectively, and described in the above-referenced publications. The drive component may comprise more than one motor, e.g., for driving more than one rotor or propeller of an aircraft or submarine vehicle.

In some examples, the drive component comprises a combustion engine. Such combustion engine can be mechanically connected to a rotor or, e.g., to a pump of a waterjet drive. In submarine applications, a combustion engine would typically be operated in an emerged or surfaced status of the submarine vehicle, as it requires oxygen to work.

In some examples, the lift component comprises a balloon connected to the hydrogen-generating apparatus through a first control valve. Controlled filling of the balloon with hydrogen from the onboard generator provides for a predetermined upward drive force, in particular if a second control valve for deflating the balloon in an controllable manner is also provided. A three-way valve may be arranged between the hydrogen-generating apparatus and the balloon and a fuel cell or combustion engine, to control the respective amount of hydrogen which is delivered into the balloon and to the fuel cell or combustion engine, respectively.

In some examples, the lift component comprises at least one electric motor coupled to a rotor. In such examples, an aircraft would work in a helicopter mode, rather than in a balloon mode. A combination of a balloon component and an electric motor can be considered for special purposes. In some examples, applicable to a submarine vehicle, the lift component may contain an electric motor coupled to a pump, to form a waterjet drive.

In some examples, the hydrogen-generating apparatus is a combined hydrogen-generating and electrical energy generating apparatus and the drive component and/or lift component comprises at least one electric motor which is connected to an electrical energy output of the combined hydrogen-generating and electrical energy generating apparatus. Such combined apparatus is part of the disclosure of the above-referenced European and U.S. patent application of the present Applicant.

This latter embodiment is particularly advantageous insofar as, in principle, the combined hydrogen-generating and electrical energy generating apparatus can provide the lift component with hydrogen and electric motor(s) in the drive component with electrical energy, in principle without having a fuel cell on board.

As mentioned further above, in some examples a hydrogen tank for storing hydrogen, to buffer the hydrogen supply of the drive component and/or the lift component can be provided. Such hydrogen tank will typically be a pressure tank and have an input port to fill it with externally produced hydrogen.

Additionally, the tank may also have a connection to the onboard hydrogen-generating apparatus, to store internally produced hydrogen. In such embodiment, a multi-way control valve unit may be provided at an output of the tank and of the hydrogen-generating apparatus, for controlling the delivery of stored hydrogen and/or of internally produced hydrogen to the drive component and/or the lift component.

In some examples, the above-referenced balloon may serve as a hydrogen reservoir for temporarily storing internally produced hydrogen and for delivering it to a fuel cell or combustion engine in case of need, to boost the real-time hydrogen delivery from the hydrogen-generating apparatus.

In some embodiments, the lift and drive unit comprises a battery and/or a supercapacitor (AKA a “supercap”) connectable to at least the drive component, to buffer the electrical energy supply thereof. Such battery or supercap can be charged in advance of operating the lift and drive unit and/or in operation thereof from the above-referenced combined hydrogen-generating and electrical energy generating apparatus.

The aircraft of the present disclosure may include a drone which, in particular, comprises a plurality of electric motors, each coupled to a rotor, and a balloon to be filled with hydrogen from the hydrogen-generating apparatus, to provide the upward force. Drones with such types of drive system can be used for many purposes, including photo or video applications and the short-distance delivery of items.

In some examples, the aircraft comprises a single combustion engine coupled to a single rotor, for providing both a forward drive force and upward drive force. This embodiment can be a drone, in particular of a bigger type which is more adapted to long-term and long-distance applications, including military applications.

In an embodiment of the submarine vehicle of the present disclosure, this is an unmanned submarine vehicle or driver assistance vehicle. Such vehicle or apparatus can, e.g., help a diver to carry heavy objects from a submarine destination, or can be controlled on a remote basis in mine sweeping or other hazardous applications.

In some examples, the drive unit of the submarine vehicle comprises a fuel cell electrically coupled to a single electric motor which is coupled to a single rotor for providing at least the forward drive force. In principle, the single rotor can be adapted and operated to provide not only the forward drive force but even the upward drive force. The motor/rotor blade can, insofar, constitute both the drive and lift components of the submarine, together with a motion control unit.

In some examples, the submarine has an independent lift unit, which comprises a balloon to be filled with hydrogen from the hydrogen-generating apparatus, to provide the upward force. This reduces the electrical energy consumption and can, thus, extend the action time of the submarine.

### Examples, Components, and Alternatives

The following describes selected aspects of illustrative lift and drive units, as well as related systems and/or methods, as depicted in the accompanying drawings. The examples below are intended for illustration and should not be interpreted as limiting the scope of the present disclosure.

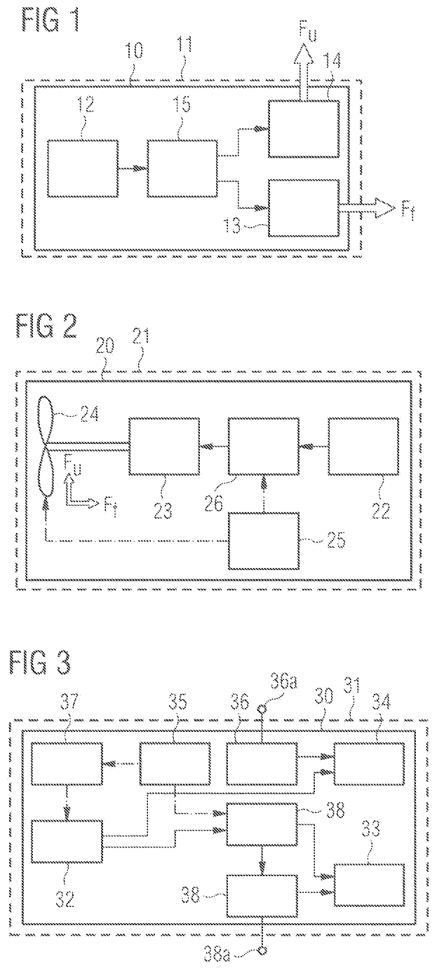

FIG. 1 shows schematically a lift and drive unit 10 of a vehicle 11, which comprises a hydrogen-generating apparatus 12, a hydrogen-based drive component 13 for providing a forward drive force Ff of the vehicle 11, and a hydrogen-based lift component 14 for providing an upward drive force Fu to move the vehicle upward. Both the drive component 13 and the lift component 14 have hydrogen inlets (not specifically designated), which are connected to a hydrogen outlet of the hydrogen-generating apparatus 12 through a hydrogen delivery control unit 15.

The hydrogen delivery control unit 15 is adapted to control the flow of hydrogen which is generated in the hydrogen-generating apparatus onboard the vehicle 11, e.g., using a control valve, throttle valve, or the like, to the drive unit 13 and the lift unit 14 according to a motion control program and optionally dependent upon signals of sensors (not shown). These sensors are configured to detect the motion status and possibly external conditions. The motion control program is configured to steer the vehicle 11 to a predetermined destination or on a predetermined route.

FIG. 2 schematically shows, likewise as a functional block diagram, a further lift and drive unit 20 of a vehicle 21 which is fueled by a hydrogen-generating apparatus 22. However, different from the embodiment of FIG. 1, the lift and drive unit 20 comprises a single engine 23, e.g., a combustion engine. Engine 23 is arranged for providing, by way of a rotor 24 mechanically connected to the engine 23, both a forward drive force Ff and an upward drive force Fu, dependent upon control signals which are prepared in and output from a motion control unit 25. In addition to any other components specifically described, control units of the present disclosure (such as hydrogen delivery control unit 15, motion control unit 25, etc.) may include any suitable electronic controller and/or processing logic configured to carry out the relevant tasks and functionality.

The control signals from the motion control unit 25 are provided to the engine/rotor combination 23/24 and may affect the operation thereof according to any suitable manner known in the art. Furthermore, the lift and drive unit 20 comprises a hydrogen buffer tank 26 arranged between the outlet of the hydrogen generating apparatus 22 and the hydrogen inlet of the engine 23, for buffering the flow of hydrogen delivered to the engine in real-time, in accordance with a motion control program which is stored in the motion control unit 25.

FIG. 3 shows, as a further functional block diagram, another lift and drive unit 30 of a vehicle 31. In this figure, components which are identically or functionally equivalent to components shown in FIG. 1 or 2, are designated with corresponding reference numerals and will not again be described in detail.

Within the lift and drive unit 30, reference numeral 32 designates a combined hydrogen-generating/electrical energy-generating apparatus 32, which can be controlled to deliver either hydrogen or electrical energy, using a generator mode control unit 37. That control unit 37 is activated by a first control signal which is output by a motion control unit 35.

Hydrogen generated by the generator 32 is delivered to a first inlet of the lift component 34. The lift component 34 has a second inlet which is connected to a hydrogen pressure tank 36. That tank 36 is a reservoir for storing pre-generated hydrogen, which is delivered to the lift and drive unit 30 through an external hydrogen inlet 36a. Different from the embodiment of FIG. 2, this tank 36 is not a buffer tank and, thus, not connected to the hydrogen outlet of the generator 32.

On the other hand, the combined generator 32 is electrically connected to the drive unit 33, which in this embodiment does not necessarily contain an internal generator of electrical energy but rather one or more electric motor(s) and rotor(s), etc. The connection is through an electrical energy distribution unit 38 which delivers the electrical energy to the drive unit 33 and/or to a buffer battery 38, in portions which are determined in response to a second control signal which is output by the motion control unit 35. The buffer battery 38 has an external re-charge port 38a for externally charging the battery prior to operating the vehicle.

Like the hydrogen pressure tank 36, the buffer battery 38 can be of any suitable commercially available type, and it can be constituted by plural battery elements or one or more supercapacitor(s).

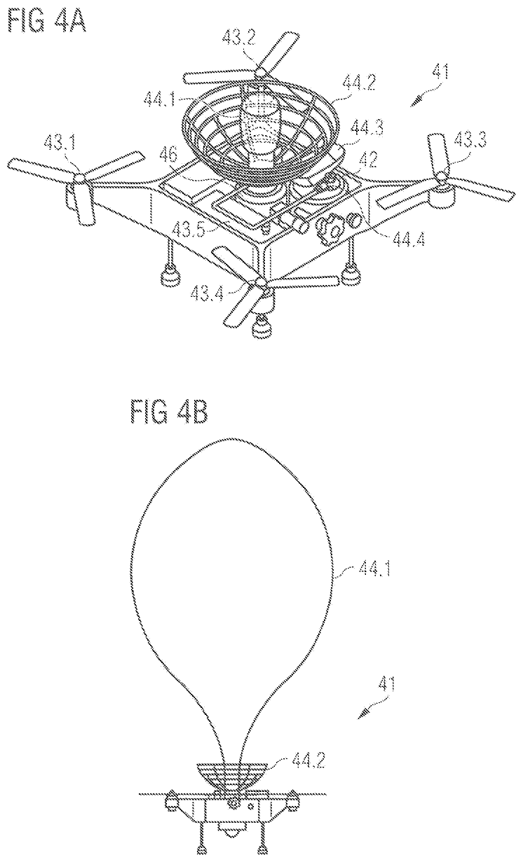

FIGS. 4A and 4B illustrate an exemplary vehicle, wherein the lift and drive unit of the present disclosure is applied, i.e., a drone (here, a quadcopter, also referred to as a quadrotor or a quadrocopter) 41. A drive unit (not separately designated) of the quadcopter 41 is constituted by four motor/propeller units 43.1, 43.2, 43.3, and 43.4. A lift unit (likewise not separately designated) comprises a balloon 44.1, protected by a basket guard 44.2 and provided with a filling funnel 44.3 and a pressure release valve 44.4.

For providing the hydrogen required to fill the balloon 44.1 and to fuel the drive unit, the quadcopter 41 comprises a hydrogen-generating apparatus 42 and a hydrogen tank 46, both of which are connected or can be connected, respectively, to a fuel cell 43.5 which forms part of the drive unit.

For raising the quadcopter, hydrogen from the hydrogen generator 42 and/or from the hydrogen tank 46 is filled into the balloon 44.1, controlled by a motion control unit (not shown). An operation mode with the balloon 44.1 filled with hydrogen, is shown in FIG. 4B.

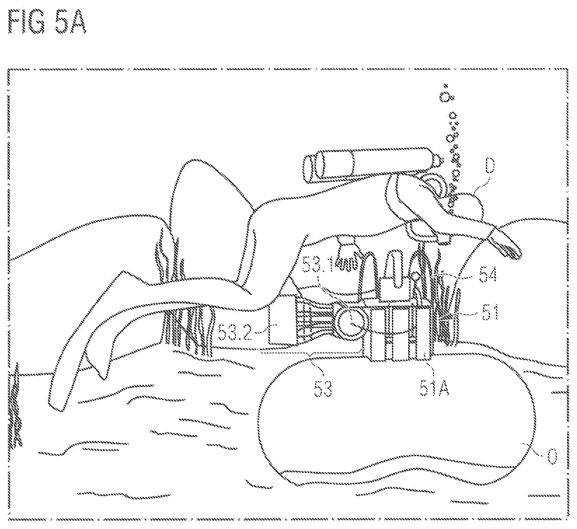

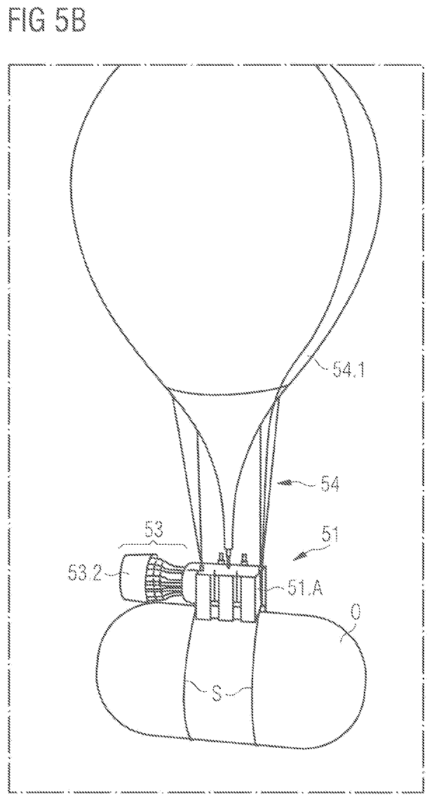

FIGS. 5A and 5B illustrate, as a further embodiment, a diver assistance apparatus 51 in a first and a second state of its use to carry an object from the sea floor to the surface. The diver assistance apparatus 51 is, in an inoperative state, guided to an object O by a diver D and is put onto the object (as shown in FIG. 5A) and fixed thereto with straps S (shown in FIG. 5B).

The apparatus 51 comprises a lift component 54 for raising the object from the floor and a drive unit 53 for moving it to a predetermined destination. The lift unit comprises a balloon 54.1 and associated equipment (not shown) for filling the balloon with hydrogen which is produced by a hydrogen-generating apparatus (not shown) within an apparatus body 51A. The drive unit 53 comprises an electric motor 53.1 and a propeller 53.2 connected to the motor, and (not shown) a fuel cell which is contained in the apparatus body 51A.

The diver manually starts the operation of the diver assistance apparatus 51, firstly actuating a valve to fill the balloon 54.1 with hydrogen and then starting the operation of the fuel cell and motor, to drive the propeller 53.2, which results in a combined upward and forward motion of the apparatus 51, together with the object O attached thereto.

### Illustrative Combinations and Additional Examples

This section describes additional aspects and features of lift and drive units for aircraft and submersible vehicles, presented without limitation as a series of paragraphs, some or all of which may be alphanumerically designated for clarity and efficiency. Each of these paragraphs can be combined with one or more other paragraphs, and/or with disclosure from elsewhere in this application, including the materials incorporated by reference in the Cross-References, in any suitable manner. Some of the paragraphs below expressly refer to and further limit other paragraphs, providing without limitation examples of some of the suitable combinations.

A0. A lift and drive unit of an aircraft or submarine vehicle, comprising:

a hydrogen-based drive component for providing a forward drive force to move the aircraft or vehicle over ground,

a hydrogen-based lift component for providing an upward drive force to move the aircraft or vehicle upward, and

a hydrogen generating apparatus, connectable to both the drive component and the lift component, for providing the drive and lift components with hydrogen which is produced within the lift and drive unit.

A1. The lift and drive unit of A0, wherein the drive component comprises a fuel cell coupled to at least one electric motor, or a combustion engine.

A2. The lift and drive unit of A0 or A1, comprising a hydrogen delivery control unit for controlling the delivery of hydrogen produced by the hydrogen generating apparatus to the drive component and to the lift component, to achieve or maintain an intended combination of a forward drive force and an upward drive force.

A3. The lift and drive unit of any one of paragraphs A0 through A2, wherein the lift component comprises a balloon connected to the hydrogen generating apparatus through a first control valve.

A4. The lift and drive unit of A3, wherein the lift component comprises a second control valve for deflating the balloon.

A5. The lift and drive unit of any one of paragraphs A0 through A4, wherein the lift component comprises at least one electric motor coupled to a rotor.

A6. The lift and drive unit of any one of paragraphs A0 through A5, wherein the hydrogen generating apparatus is a combined hydrogen generating and electrical energy generating apparatus and the drive component and/or lift component comprises at least one electric motor which is connected to an electrical energy output of the combined hydrogen generating and electrical energy generating apparatus.

A7. The lift and drive unit of any one of paragraphs A0 through A6, comprising a hydrogen pressure tank connectable to at least one of the drive component and lift component, to buffer the hydrogen supply of the drive component and/or the lift component.

A8. The lift and drive unit of any one of paragraphs A0 through A7, comprising a battery and/or a supercap connectable to at least the drive component, to buffer the electrical energy supply thereof.

B0. An aircraft, in particular a drone, comprising a lift and drive unit of any one of paragraphs A0 through A8.

B1. The aircraft of B0, wherein the aircraft comprises a plurality of electric motors, each coupled to a rotor, and a balloon to be filled with hydrogen from the hydrogen generating apparatus, to provide the upward force.

B2. The aircraft of B0, comprising a single combustion engine coupled to a single rotor, for providing both a forward drive force and upward drive force.

C0. A submarine vehicle, in particular unmanned submarine vehicle or driver assistance vehicle, comprising a lift and a drive unit of any one of paragraphs A0 through A8.

C1. The submarine vehicle of C0, wherein the drive unit comprises a fuel cell electrically coupled to a single electric motor which is coupled to a single rotor for providing at least the forward drive force.

C2. The submarine vehicle of C0 or C1, comprising a balloon to be filled with hydrogen from the hydrogen generating apparatus, to provide the upward force.

### Conclusion

The disclosure set forth above may encompass multiple distinct examples with independent utility. Although each of these has been disclosed in its preferred form(s), the specific embodiments thereof as disclosed and illustrated herein are not to be considered in a limiting sense, because numerous variations are possible. To the extent that section headings are used within this disclosure, such headings are for organizational purposes only. The subject matter of the disclosure includes all novel and nonobvious combinations and subcombinations of the various elements, features, functions, and/or properties disclosed herein. The following claims particularly point out certain combinations and subcombinations regarded as novel and nonobvious. Other combinations and subcombinations of features, functions, elements, and/or properties may be claimed in applications claiming priority from this or a related application. Such claims, whether broader, narrower, equal, or different in scope to the original claims, also are regarded as included within the subject matter of the present disclosure.

1. A lift and drive unit for an aircraft or submarine vehicle, the lift and drive unit comprising:
a hydrogen-based drive component configured to provide a forward drive force to propel the aircraft or submarine vehicle over ground;
a hydrogen-based lift component configured to provide an upward drive force to move the aircraft or submarine vehicle upward; and
a hydrogen generating apparatus, connectable to both the drive component and the lift component, configured to supply the drive and lift components with a hydrogen supply which is produced within the lift and drive unit.

2. The lift and drive unit of claim 1, wherein the hydrogen-based drive component comprises a fuel cell coupled to at least one electric motor.

3. The lift and drive unit of claim 1, further comprising a hydrogen delivery control unit configured to control delivery of hydrogen produced by the hydrogen generating apparatus to the drive component and to the lift component, so as to achieve or maintain an selected combination of the forward drive force and the upward drive force.

4. The lift and drive unit of claim 1, wherein the hydrogen-based lift component comprises a balloon connected to the hydrogen generating apparatus through a first control valve.

5. The lift and drive unit of claim 4, wherein the hydrogen-based lift component comprises a second control valve configured to selectively deflate the balloon.

6. The lift and drive unit of claim 1, wherein the hydrogen-based lift component comprises at least one electric motor coupled to a rotor.

7. The lift and drive unit of claim 1, wherein the hydrogen generating apparatus is a combined hydrogen generating and electrical energy generating apparatus, and the hydrogen-based drive component comprises at least one electric motor operatively connected to an electrical energy output of the combined hydrogen generating and electrical energy generating apparatus.

8. The lift and drive unit of claim 1, further comprising a hydrogen pressure tank connectable to at least one of the hydrogen-based drive component and the hydrogen-based lift component, wherein the hydrogen pressure tank is configured to buffer the hydrogen supply.

9. The lift and drive unit of claim 1, further comprising a battery and/or a supercapacitor connectable to at least the hydrogen-based drive component and configured to buffer an electrical energy supply thereof.

10. An aircraft comprising the lift and drive unit of claim 1.

11. The aircraft of claim 10, wherein the aircraft comprises a plurality of electric motors each coupled to a rotor, and a balloon operatively coupled to the hydrogen generating apparatus.

12. The aircraft of claim 10, further comprising a single combustion engine coupled to a single rotor configured to provide both the forward drive force and the upward drive force.

13. The aircraft of claim 10, wherein the aircraft comprises a drone aircraft.

14. A submarine vehicle comprising the lift and drive unit of claim 1.

15. The submarine vehicle of claim 14, wherein the hydrogen-based drive unit comprises a fuel cell electrically coupled to a single electric motor, wherein the single electric motor is operatively coupled to a single rotor configured to provide at least the forward drive force.

16. The submarine vehicle of claim 14, further comprising a balloon operatively coupled to the hydrogen generating apparatus and configured to provide the upward force.

17. The submarine vehicle of claim 14, wherein the submarine vehicle is an unmanned submarine vehicle or a diver assistance vehicle.

18. The lift and drive unit of claim 1, wherein the hydrogen-based drive component comprises a combustion engine.

19. The lift and drive unit of claim 1, wherein the hydrogen generating apparatus is a combined hydrogen generating and electrical energy generating apparatus, and the hydrogen-based lift component comprises at least one electric motor operatively connected to an electrical energy output of the combined hydrogen generating and electrical energy generating apparatus.
